(19) United States
(12) Patent Application Publication
(10) Pub. No.: US 2013/0127259 A1
(43) Pub. Date: May 23, 2013

(54) DEVICE AND METHOD FOR INDUCTIVE POWER TRANSMISSION

(71) Applicant: ROBERT BOSCH GMBH, Stuttgart (DE)

(72) Inventors: Guenter LOHR, Leinfelden-Echterdingen (DE); Juergen MACK, Goeppingen (DE)

(73) Assignee: ROBERT BOSCH GMBH, Stuttgart (DE)

(21) Appl. No.: 13/677,522

(22) Filed: Nov. 15, 2012

(30) Foreign Application Priority Data
Nov. 23, 2011 (DE) 10 2011 086 904.2

(51) Int. Cl. H01F 38/14

(52) U.S. Cl. CPC H01F 38/14
USPC 307/104

(57) ABSTRACT

A device for inductive power transmission includes an oscillating circuit having an inductance and a capacitance, a power component for exciting an electric oscillation in the oscillating circuit, a determination unit for determining an input current of the power component, and a frequency shifting unit designed to vary a resonant frequency of the oscillating circuit.

### CROSS REFERENCE TO RELATED APPLICATION

The present application claims priority to Application No. DE 10 2011 086 904.2, filed in the Federal Republic of Germany on Nov. 23, 2011, which is expressly incorporated herein in its entirety by reference thereto.

### FIELD OF INVENTION

The present invention relates to a device for inductive power transmission, and a method for operating such a device.

### BACKGROUND INFORMATION

Devices and methods for inductive power transmission are known from the related art. Such devices are used for charging batteries of small electrical equipment. A magnetic field is used for power transmission between a transmitting unit (charging station) and a receiving unit (battery pack).

Known devices for inductive power transmission are usually designed as resonant converters. Resonant converters include essentially a resonant capacitance and a resonant inductance, together forming a resonant transformer. The resonant frequency of the resonant transformer is determined by the resonant capacitance and the resonant inductance. Inductive coupling between the resonant inductance of the charging station and a coil of the receiving unit is required in order for power to be transmitted from the charging station to the receiving unit. Such inductive coupling usually exists for short distances from a few millimeters up to a few centimeters. In the case of a resonant inductive coupling, the distance between the transmitting unit and the receiving unit may be increased while maintaining a relatively high degree of efficiency.

The geometrically defined and spatially limited area in which the power transmission may take place via the resonant inductive coupling with a sufficiently high degree of efficiency is known as the interface. In inductive charging, the possibility must not be ruled out that foreign objects come to be situated between the transmitting unit and the receiving unit in the area of the interface. The foreign object may heat up to a very great extent, depending on the material, the geometry and the position of the foreign object inside the magnetic alternating field used for the power transmission. The physically induced voltage in the foreign object results in eddy current losses and, in the case of ferromagnetic materials in particular, remagnetization losses and hysteresis losses.

It is known that the interface between the transmitting unit and the receiving unit may be designed geometrically to make it difficult to inadvertently introduce foreign objects. German Application No. DE 10 2005 045 360 A1 also describes how a frequency of a power supply voltage of a transmitting unit may be increased in the presence of a foreign object in such a way that an oscillation amplitude in the transmission oscillating circuit of the transmitting unit assumes a maximal value despite the foreign object. The foreign object is then heated to a high temperature under some circumstances, which may result in damage to the foreign object, the transmitting unit and/or the receiving unit. This also entails a risk of injury to anyone present in the surroundings.

### SUMMARY

An object of the present invention is therefore to provide an improved device for inductive power transmission. Another object of the present invention is to provide a method for operating such a device for inductive power transmission.

A device according to the present invention for inductive power transmission includes an oscillating circuit which has an inductance and a capacitance, a power component for exciting an electrical oscillation in the oscillating circuit and a determination unit for determining an input current of the power component. Furthermore, the device also includes a unit designed to vary a resonant frequency of the oscillating circuit. This device is advantageously designed to reliably detect the presence of even small foreign objects in the area of the interface. This is done on the basis of the knowledge that a power absorbed in the foreign object and therefore a power loss will increase with an increase in the frequency of the magnetic alternating field. The presence of a foreign object may therefore be detected more reliably if a frequency much higher than the frequency used for power transmission is used for detecting a foreign object.

In a preferred exemplary embodiment of the device, the unit is designed to vary a capacitance of the oscillating circuit. The variation in the capacitance of the oscillating circuit may advantageously be accomplished with low complexity in terms of the technical circuitry by serial or parallel connection of an additional capacitor.

In another exemplary embodiment of the device, the unit is designed to vary an inductance of the oscillating circuit. Varying an inductance of an oscillating circuit advantageously also requires only a low level of complexity in terms of the technical circuitry.

A method according to the present invention for operating a device for inductive power transmission has steps for varying a resonant frequency of the oscillating circuit of the device, for determining an input current of a power component of the device and for comparing the input current with a threshold value to infer the presence of a foreign object between the device and a power receiver. This method advantageously allows reliable detection of even small foreign objects. The safety and reliability of the device for inductive power transmission are therefore increased.

In one exemplary embodiment of the method, the presence of a foreign object between the device and the power receiver is inferred when the input current is above the threshold value. An input current of the power component which is above a threshold value is advantageously a reliable indication of power absorbed between the device and the power receiver.

It is advantageous that the resonant frequency is varied to a value between 250 kHz and 1 MHz. This frequency range is advantageously a definite distance away from a frequency range between 25 kHz and 150 kHz, which is used for power transmission, and has proven suitable in experiments and for detection of even small foreign objects.

In one exemplary embodiment of the method, the resonant frequency is varied by varying a capacitance of the oscillating circuit. The variation in the capacitance of the oscillating circuit may advantageously be implemented with low complexity in terms of the technical circuitry.

In another exemplary embodiment of the method, the resonant frequency is varied by varying an inductance of the oscillating circuit. The variation in inductance of the oscillating circuit is advantageously also possible with low complexity in terms of the technical circuitry.

In a preferred exemplary embodiment of the method, the method is carried out before the device begins with a power transmission to a power receiver. This advantageously ensures that any foreign object situated between the device and the power receiver will not be heated by a power transmission.

In an additional exemplary refinement of the method, this is performed repeatedly and periodically during a power transmission to a power receiver. In this way, also a subsequent introduction of a foreign object into an area between the device and a power receiver may advantageously be detected.

Exemplary embodiments of the present invention will now be explained in greater detail with reference to the accompanying drawings.

### BRIEF DESCRIPTION OF THE DRAWINGS

FIG. 1 shows a schematic diagram of a system for inductive power transmission.

FIG. 2 shows a simplified circuit configuration of the system for inductive power transmission.

### DETAILED DESCRIPTION

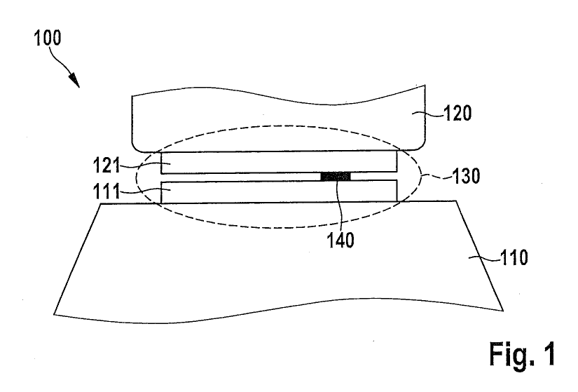

FIG. 1 shows a highly schematized diagram of a system 100 for inductive power transmission. System 100 for inductive power transmission includes a device 110 for inductive power transmission and a power receiver 120. Device 110 for inductive power transmission may be a charging device or a charging cradle, for example. Power receiver 120 may be, for example, a cordless small electrical device. For example, power receiver 120 may be an electric toothbrush or a cell phone.

Device 110 for inductive power transmission is designed to charge an energy store of power receiver 120, for example, a battery pack or an accumulator pack without a cable connection between device 110 for inductive power transmission and power receiver 120. Device 110 for inductive power transmission has a transmitting unit 111 for this purpose. Power receiver 120 has a receiving unit 121. Transmitting unit 111 and receiving unit 121 are designed to be able to approach each other except for a small distance. In the example illustrated in FIG. 1, transmitting unit 111 and receiving unit 121 are each designed with flat surfaces. Power receiver 120 may therefore be placed on device 110 for inductive power transmission to bring receiver unit 121 closer to transmitting unit 111.

The spatial area formed by transmitting unit 111 of device 110 for inductive power transmission and receiving unit 121 of power receiver 120 is referred to as interface 130. There must not be any objects in the area of interface 130 during a power transmission from device 110 for inductive power transmission to power receiver 120. If there were, these objects could be heated up during the power transmission, which could result in damage to the object, to device 110 for inductive power transmission and/or to power receiver 120 and in a risk of injury to anyone in the surroundings. However, in the example shown in FIG. 1, a foreign object 140 is situated in the area of interface 130 between transmitting unit 111 of device 110 for inductive power transmission and receiving unit 121 of power receiver 120. System 100 for inductive power transmission must detect this foreign object 140 and suppress power transmission between device 110 and power receiver 120 to prevent heating of foreign object 140.

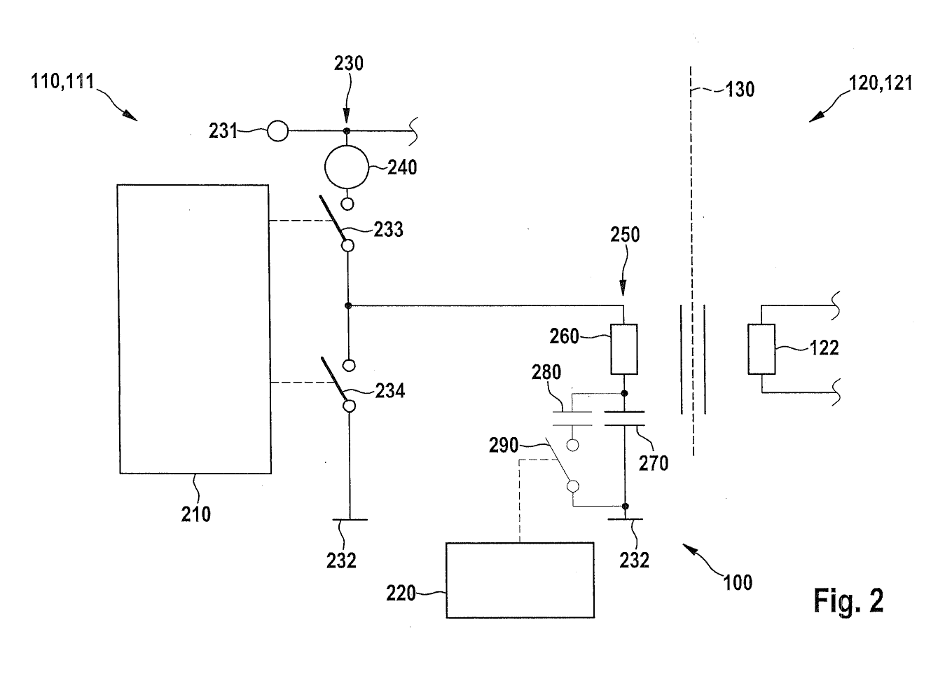

FIG. 2 shows a schematized circuit configuration of system 100 for inductive power transmission. This shows circuit parts of transmitting unit 111 of device 110 for inductive power transmission and circuit parts of receiving unit 121 of power receiver 120.

Transmitting unit 111 of device 110 for inductive power transmission includes an oscillating circuit 250 having a transmitting coil 260 and a first capacitor 270. A first electrical contact of first capacitor 270 is connected to a ground contact 232. A second contact of first capacitor 270 is connected to a first contact of transmitting coil 260. A second contact of transmitting coil 260 is connected to a power component 230, designed as a half-bridge in the example shown in FIG. 2. Power component 230 includes a first switch 233 and a second switch 234. The second contact of transmitting coil 260 may be connected to a power supply voltage contact 231 by opening second switch 234 and closing first switch 233. The second contact of transmitting coil 260 may be connected to ground contact 232 by opening first switch 233 and closing second switch 234.

A first control unit 210 of transmitting unit 111 of device 110 for inductive power transmission is responsible for the opening and closing of first switch 233 and of second switch 234. First control unit 210 may include a microcontroller or a microcomputer, for example. First control unit 210 operates switches 233, 234, in such a way that at most one of switches 233, 234 is closed, i.e., electrically conductive, at each point in time.

If first switch 233 is closed, a first electric current flows through transmitting coil 260 of oscillating circuit 250 and charges first capacitor 270 of oscillating circuit 250 to the electric power supply voltage applied to power supply voltage contact 231. If first switch 233 is opened and second switch 234 is closed, a second electric current flows through transmitting coil 260, which discharges first capacitor 270 to ground contact 232. A periodic alternating current may thus be excited in oscillating circuit 250 by alternating and periodic opening and closing of switches 233, 234. The amplitude of the electric alternating current flowing in oscillating circuit 250 reaches a maximum when the frequency at which first control unit 210 opens and closes switches 233, 234 corresponds to a resonant frequency of oscillating circuit 250 determined by the inductance of transmitting coil 260 and the capacitance of first capacitor 270.

Transmitting unit 111 of device 110 for inductive power transmission has a current measuring device 240, which is designed for determining an input current of power component 230. In the example illustrated in FIG. 2, current measuring device 240 is situated between first switch 233 and power supply voltage contact 231. However, current measuring device 240 could also be situated between power component 230 and transmitting coil 260, for example.

The electric alternating current flowing through transmitting coil 260 induces a magnetic alternating field, which is generated by transmitting coil 260 in the area of interface 130. Receiving unit 121 of power receiver 120 has a receiving coil 122, which is situated so close to transmitting coil 260 of transmitting unit 111 that a magnetic alternating field generated by transmitting coil 260 induces an alternating current flow in receiving coil 122. The alternating current induced in receiving coil 122 of receiving unit 121 is used by power receiver 120 for charging an energy store.

To transmit power between device 110 for inductive power transmission and power receiver 120, first control unit 210 switches power component 230 to a frequency between 25 kHz and 150 kHz, for example. This excites oscillation in oscillating circuit 250 at precisely this frequency.

If there is a foreign object 140 in the area of interface 130, as shown in FIG. 1, then a portion of the power emitted by device 110 for inductive power transmission is absorbed by foreign object 140. Foreign object 140 therefore heats up. Consequently, an input current of power component 230 increases, this being detectable with the aid of current measuring unit 240. However, the power absorbed by foreign object 140 may be low if foreign object 140 itself is small. In this case, detection of the increase in the input current of power component 230 may prove to be unreliable.

However, the power absorbed by foreign object 140 increases with the frequency of the magnetic alternating field generated by device 110 for inductive power transmission. The increase in the input current of power component 230, which is induced due to the absorption by foreign object 140, therefore grows at the frequency of the oscillation excited in oscillating circuit 250 of transmitting unit 111. The increase in the input current of power component 230 and thus the presence of foreign object 140 are more readily detectable at a higher frequency than at the lower frequency used for power transmission between device 110 for inductive power transmission and power receiver 120.

Device 110 for inductive power transmission is therefore designed to increase the frequency of the electrical oscillation excited in oscillating circuit 250 for the purpose of detection of the possible presence of foreign object 140. The resonant frequency of oscillating circuit 250 is therefore increased. Transmitting unit 111 of device 110 for inductive power transmission has a second capacitor 280, which may be connected in parallel to first capacitor 270 with the aid of a third switch 290. In an alternative exemplary embodiment, an additional coil could also be connected in series with transmitting coil 260 of oscillating circuit 250 or in parallel with transmitting coil 260. A second control unit 220 is provided to open and close third switch 290. Second control unit 220 and first control unit 210 may also be designed as a joint control unit.

The resonant frequency of oscillating circuit 250 is shifted toward a higher frequency due to removal of second capacitor 280 from oscillator circuit 250 (and/or due to insertion of an additional inductance into or removal from oscillating circuit 250). The higher frequency may be in a range between 250 kHz and 1 MHz, for example. If the resonant frequency of oscillating circuit 250 is shifted toward the higher value, first control unit 210 operates switches 233, 234 of power component 230 at the same higher frequency to excite oscillation in oscillating circuit 250 at the higher frequency.

If a foreign object 140 is present, the power absorbed by foreign object 140 increases at the higher frequency, which is manifested by an increase in the input current of power component 230. Transmitting unit 111 ascertains the input current of power component 230 with the aid of current measuring unit 240 and compares the size of this input current with a fixed threshold value. If the size of the input current exceeds the threshold value, then the presence of a foreign object 140 may be inferred. In this case, there must not be any power transmission from device 110 for inductive power transmission to power receiver 120 since otherwise excessive heating of foreign object 140 would have to be feared. However, if the input current of power component 230 ascertained with the aid of current measuring unit 240 is below the threshold value, then no foreign object 140 is present. In this case, the resonant frequency of oscillating circuit 250 is reduced back to the lower level by the closing of switch 290 and thus the insertion of second capacitor 280 into oscillating circuit 250. A power transmission from device 110 for inductive power transmission to power receiver 120 is subsequently carried out.

The method described here for detection of foreign object 140 may be carried out by device 110 for inductive power transmission before the latter begins a power transmission to power receiver 120. The test described may also be carried out with periodic repetition during power transmission from device 110 to power receiver 120. The test may be carried out once per minute, for example. The time interval between two successive tests may also be adjusted dynamically. For example, a test may be carried out more often if the input current ascertained is close to the threshold value.

What is claimed is:

1. A device for inductive power transmission, comprising:
an oscillating circuit having an inductance and a capacitance;
a power component configured for exciting an electric oscillation in the oscillating circuit;
a determination unit configured for determining an input current of the power component; and
a frequency shifting unit configured to vary a resonant frequency of the oscillating circuit.

2. The device according to claim 1, wherein the frequency shifting unit is configured to vary the capacitance of the oscillating circuit.

3. The device according to claim 1, wherein the frequency shifting unit is configured to vary the inductance of the oscillating circuit.

4. A method for operating a device for inductive power transmission, comprising:
varying a resonant frequency of an oscillating circuit of the device;
determining an input current of a power component of the device; and
comparing the input current with a threshold value to infer a presence of a foreign object between the device and a power receiver.

5. The method according to claim 4, wherein the presence of the foreign object between the device and the power receiver is inferred when the input current is above the threshold value.

6. The method according to claim 4, wherein the resonant frequency is varied to a value between 250 kHz and 1 MHz.

7. The method according to claim 4, wherein the resonant frequency is varied by varying a capacitance of the oscillating circuit.

8. The method according to claim 4, wherein the resonant frequency is varied by varying an inductance of the oscillating circuit.

9. The method according to claim 4, wherein the method is carried out before the device begins a power transmission to the power receiver.

10. The method according to claim 4, wherein the method is carried out with periodic repetition during a power transmission to the power receiver.
